(19) United States
(12) Patent Application Publication
(10) Pub. No.: US 2007/0284804 A1
(43) Pub. Date: Dec. 13, 2007

(54) Document feeding device and image reading apparatus using the same

(75) Inventors: Sohichi Takata, Kitakatsuragi-gun (JP); Yasumasa Morimoto, Kashihara-shi (JP); Hirotoshi Iemura, Nara-shi (JP); Masato Tamehira, Nara-shi (JP); Yoshinori Shiraishi, Tenri-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/797,049

(22) Filed: Apr. 30, 2007

(30) Foreign Application Priority Data
May 9, 2006 (JP) 2006-130521

(51) Int. Cl. B65H 5/18; B65H 7/00; G06K 9/00

(52) U.S. Cl. 271/10.11; 382/113

(57) ABSTRACT

An automatic document processor for automatically conveying documents includes: a document tray; a document feed path for introducing and feeding originals from the document tray into the interior of a machine; a document pickup roller assembly for picking up originals, page by page, from the document tray; and a document drive roller for conveying originals, and is constructed such that the pickup roller assembly includes two units of document pickup rollers and a pickup roller selecting mechanism for selecting the document pickup rollers to be operated, in accordance with the document size is provided.

This Nonprovisional application claims priority under 35 U.S.C. §119(a) on Patent Application No. 2006-130521 filed in Japan on 9 May 2006, the entire contents of which are hereby incorporated by reference.

### BACKGROUND OF THE INVENTION

(1) Field of the Invention

The present invention relates to a document feeding device and an image reading apparatus using it, and in particular relates to a document feeding device capable of automatic feed of documents and an image reading apparatus that reads images from the documents fed by the aforementioned device.

(2) Description of the Prior Art

Conventionally, in the image reader used in image forming apparatuses such as copiers, scanner devices, facsimile machines and the like, it is usual that originals of a fixed size are set on the image reader, fixed at the loaded position by a document positioning member, and then conveyed for original image reading. In such image readers, most of the machines use a configuration in which the reference position based on which the originals are set is formed at the document center with respect to the direction perpendicular to the document's direction of conveyance. The reason for adopting this configuration is to improve the processing efficiency when the documents to be conveyed is scanned.

Recently, there is an increasing demand for high-speed configurations of image forming apparatus so that the number of printouts to be processed per unit time increases. With this trend an increased number of originals needs to be loaded on an automatic document reader. That is, in a conventional document reader, the number of documents to be loaded was 30 to 40 sheets whereas, in a current configuration, 100 to 150 sheets of documents are loaded on the image reader.

Under such circumstances, the loaded originals are not always of a fixed document size, but originals of different sizes could be set together on the stacking portion.

In general, originals are picked up and fed from the document stacking portion, sheet by sheet, by a pickup roller. When originals of different sizes are loaded together on the document stacking portion, there occurs the problem of correct reading being corrupted due to mis-feeding or skew feeding of documents resulting from differences in size, paper weighting and rigidity of paper between the documents, and there further occurs a risk of the original documents being damaged.

To deal with this, there has been proposed as a conventional technique which, in order to correctly pick up sheets, one by one, from a stack of sheets, includes a pressure sensor for detecting the pressure between the sheets and the pickup roller and a contact pressure actuator that operates in accordance with the output from the pressure sensor so as to convey the sheet by applying a suitable contact pressure by the pickup roller, regardless of the type and size of the sheets (Japanese Patent Application Laid-open Hei 11-217124).

It is true that the aforementioned conventional technique is effective in taking countermeasures against sheet feed failure and double sheet feeding of recording paper by changing the sheet size for each paper, but in feeding original documents, if two or more sizes of originals are mixed, the problem of the documents being prone to be conveyed on a skew remains unsolved because the contact position of original documents with the pickup roller varies.

### SUMMARY OF THE INVENTION

The present invention has been devised in view of the above conventional problems, it is therefore an object of the present invention to provide a document feeding device and an image reading apparatus using it, which enable correct document feed and exact image reading by preventing mis-feeding, double feeding, skew feeding of the documents to be fed without being influenced by the size, weighting and material of the documents to be loaded.

The document feeding device and the image reading apparatus using it for solving the aforementioned problems according to the present invention are configured as follows.

A document feeding device according to the first aspect of the present invention is a document feeding device for automatically feeding documents, comprising: a document tray capable of accommodating multiple pages of originals; a document feed path for introducing and feeding originals from the document tray into the interior of a machine; a pickup roller assembly for picking up and delivering originals, page by page, from the document tray to the document feed path; and a document conveyor for conveying the original fed into the document feed path, and is characterized in that the pickup roller assembly includes a plurality of pickup rollers and a pickup roller selector for selecting the pickup rollers to be operated, from the multiple pickup rollers, at least in accordance with the document size or the weighting of the document.

A document feeding device according to the second aspect of the present invention has the configuration described in the above first aspect, and is further characterized in that the pickup roller selector selects pickup rollers to be operated in accordance with a request for document reading, input to the document feeding device.

A document feeding device according to the third aspect of the present invention has the configuration described in the above first aspect, and is further characterized in that the pickup roller selector selects pickup rollers to be operated in accordance with the set position of document positioning plates for regulating the loaded position of documents in conformity with the size of the documents staked on the document tray.

A document feeding device according to the fourth aspect of the present invention has the configuration described in any one of the above first to third aspects, and is further characterized in that the pickup roller is comprised of a roller holding member that is supported by a drive shaft coupled to a drive source for document feed for driving the document conveyor and a drive transmitter for transmitting the drive from the drive shaft, and a pickup roller shifter which pivots the pickup roller on the coaxial axis with the drive shaft to bring the pickup roller into, and out of, contact with the original is provided.

A document feeding device according to the fifth aspect of the present invention has the configuration described in the above fourth aspect, and is further characterized in that the pickup roller shifter has a cam element and shifts the position of the pickup roller by rotating the cam element.

A document feeding device according to the sixth aspect of the present invention has the configuration described in the above fifth aspect, and is further characterized in that the pickup roller shifter is adapted to vary the contact pressure between the pickup roller and the original depending on the shape of the cam element.

A document feeding device according to the seventh aspect of the present invention has the configuration described in any one of the above first to sixth aspects, and is further characterized in that the contact pressure between the pickup roller and the document is set to be maximized for the pickup roller arranged close to the document placement reference position and become smaller for one that is located more distant from the reference position.

A document feeding device according to the eighth aspect of the present invention has the configuration described in any one of the above first to sixth aspects, and is further characterized in that the contact pressure between the pickup roller and the document is set to become smaller as the size of the original is smaller and as the weighting of the original is smaller.

A document feeding device according to the ninth aspect of the present invention has the configuration described in any one of the above first to eighth aspects, and is further characterized in that a registration roller for controlling document feed is arranged downstream of the pickup roller assembly with respect to the document's direction of conveyance.

An image reading apparatus according to the tenth aspect of the present invention is an image reading apparatus for reading originals automatically, comprising: an image reading portion for scanning an original image line-wise to convert the image into electric signals by a photoelectric transducer and output the signals; and a document feeding device for automatically feeding originals, and is characterized in that the document feeding device comprises a document feeding device defined in any one of the above first to ninth aspects.

According to the first aspect of the invention, in the document feeding device for automatically feeding documents including: a document tray capable of accommodating multiple pages of originals; a document feed path for introducing and feeding originals from the document tray into the interior of a machine; a pickup roller assembly for picking up and delivering originals, page by page, from the document tray to the document feed path; and a document conveyor for conveying the original fed into the document feed path, the pickup roller assembly includes a plurality of pickup rollers and a pickup roller selector for selecting the pickup rollers to be operated, from the multiple pickup rollers, at least in accordance with the document size or the weighting of the document. This configuration allows the pickup rollers located at optimal positions to operate in accordance with the document size or the document weighting, so that it is possible to prevent mis-feed of documents, multiple page feeding and skewing pages from occurring without regarding to the size, weighting and material of the loaded documents. As a result it is possible to provide a document feeding device that is capable of achieving correct document feed and exact image reading.

In accordance with the second to ninth aspects of the present invention, the following effects can be obtained in addition to the above common effect that can be obtained from the first aspect of the invention.

That is, according to the second aspect of the invention, the pickup roller selector is configured to select pickup rollers to be operated in accordance with a request for document reading, input to the document feeding device. Accordingly, it is possible to easily operate the pickup rollers based on the input signal, without providing any separate sensor for detecting the document size, the document weighting and the like.

In accordance with the third aspect of the present invention, the pickup roller selector is configured to select pickup rollers to be operated in accordance with the set position of document positioning plates for regulating the loaded position of documents in conformity with the size of the documents stacked on the document tray. Accordingly, this configuration, in addition to the effect achieved by the first aspect of the invention, makes it possible to select the pickup rollers to be operated, exactly and reliably, in accordance with the document size.

In accordance with the fourth aspect of the present invention, the pickup roller is comprised of a roller holding member that is supported by a drive shaft coupled to a drive source for document feed for driving the document conveyor and a drive transmitter for transmitting the drive from the drive shaft. Accordingly, this configuration, in addition to the effect achieved by any one of the first to third aspects of the invention, makes it possible to drive the pickup rollers by a space-saving and simple structure without the need of providing a separate driver for driving the pickup rollers. Further, since a pickup roller shifter which pivots the pickup roller on the coaxial axis with the drive shaft to bring the pickup roller into, and out of, contact with the original is provided, this makes it possible to shift the pickup rollers in a limited space.

In accordance with the fifth aspect of the present invention, since the pickup roller shifter has a cam element and shifts the position of the pickup roller by rotating the cam element, this configuration, in addition to the effect achieved by to the fourth aspect of the invention, facilitates the pickup rollers to be shifted with a simple structure.

In accordance with the sixth aspect of the present invention, since the pickup roller shifter is configured to vary the contact pressure between the pickup roller and the original depending on the shape of the cam element, this configuration, in addition to the effect achieved by to the fourth aspect of the invention, makes it possible to produce desired contact pressure with a simple structure.

In accordance with the seventh aspect of the present invention, the contact pressure between the pickup roller and the document is set to be maximized for the pickup roller arranged close to the document placement reference position and become smaller for one that is located more distant from the reference position. As a result, in addition to the effect achieved by any one of the first to sixth aspects of the invention, the original can be efficiently conveyed in the document's direction of conveyance by the pickup roller located close to the document placement reference position while the pickup roller that is distant from the reference position can be used to drive the original in an auxiliary manner, hence it is possible to prevent the original from being fed on a skew.

In accordance with the eighth aspect of the present invention, since the contact pressure between the pickup roller and the document is set to become smaller as the size of the original is smaller and as the weighting of the original is smaller, this configuration, in addition to the effect achieved by any one of the first to sixth aspects of the invention, makes it possible to convey the original under an optimal contact pressure in conformity with the size and/or weight of the original being conveyed, without imposing extra load on the apparatus and the original.

In accordance with the ninth aspect of the present invention, a registration roller for controlling document feed is arranged downstream of the pickup roller assembly with respect to the document's direction of conveyance. As a result, even if the original is fed skewing by the pickup roller at the beginning of conveyance, the portion of the original reaching the registration roller first can be checked from advancing while the other delaying side of the original is conveyed by the appropriate pickup roller. Accordingly, this configuration, in addition to the effect achieved by any one of the first to eighth aspects of the invention, makes it possible to return an incorrect original feed state to the normal feed state, hence it is possible to reliably feed originals straight.

Further, according to the tenth aspect of the invention, in the image reading apparatus for reading originals automatically, comprising: an image reading portion for scanning an original image line-wise to convert the image into electric signals by a photoelectric transducer and output the signals; and a document feeding device for automatically feeding originals, one of the document feeding devices defined in the above first to ninth aspects is used as its document feeding device. Accordingly, this configuration allows the pickup rollers located at optimal positions to operate in accordance with the document size or the document weighting, so that it is possible to prevent mis-feed of documents, multiple page feeding and skewing pages from occurring without regarding to the size, weighting and material of the loaded documents. As a result it is possible to provide an image reading apparatus that is capable of achieving correct document feed and exact image reading.

### BRIEF DESCRIPTION OF THE DRAWINGS

FIG. 1 is a perspective view showing an overall configuration of an image forming apparatus according to the embodiment of the present invention;

FIG. 2 is a sectional side view showing an internal configuration of the image forming apparatus;

FIG. 3 is a block diagram showing a configuration of an electric controller of the image forming apparatus;

FIG. 4 is an illustrative view showing a schematic configuration of an automatic document processor that constitutes an image reading apparatus provided for the image forming apparatus;

FIG. 5 is an illustrative view showing a pickup roller configuration provided for the automatic document processor;

FIG. 6A is an illustrative view showing the pickup roller being retracted; and FIG. 6B is an illustrative view showing the pickup roller being active;

FIG. 7A is an illustrative view showing a state in which the document pickup rollers are kept away from an original by the function of a pickup roller selecting mechanism that constitutes the automatic document processor; FIG. 7B is an illustrative view showing a state in which one of the document pickup rollers is selectively made to abut the original by the pickup roller selecting mechanism; and FIG. 7C is an illustrative view showing a state in which all the document pickup rollers are made to abut the original by the pickup roller selecting mechanism;

FIG. 8 is an illustrative view showing a document feed state in which an original is fed by the automatic document processor with its center adjusted to the center reference;

FIG. 9 is an illustrative view showing a document feed state in which an original is fed by the automatic document processor with its center not adjusted to the center reference;

FIG. 10 is an illustrative view showing a document feed state in which document pickup rollers are selectively operated in accordance with a case where an original is fed by the automatic document processor with its center not adjusted to the center reference;

FIG. 11 is an illustrative view showing a variational example of a pickup roller selecting mechanism according to the present embodiment; and

FIG. 12 is an illustrative view showing a variational example of document pickup rollers according to the present embodiment.

### DESCRIPTION OF THE PREFERRED EMBODIMENTS

The embodiment of the present invention will hereinafter be described in detail with reference to the drawings.

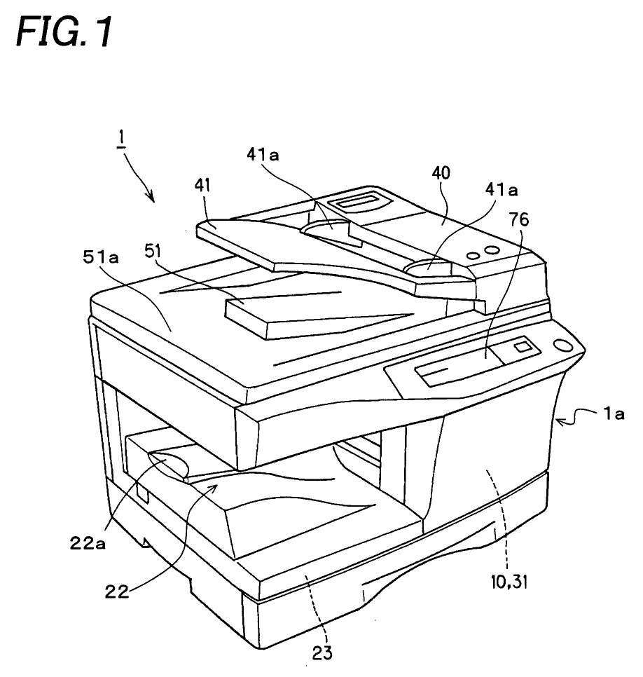

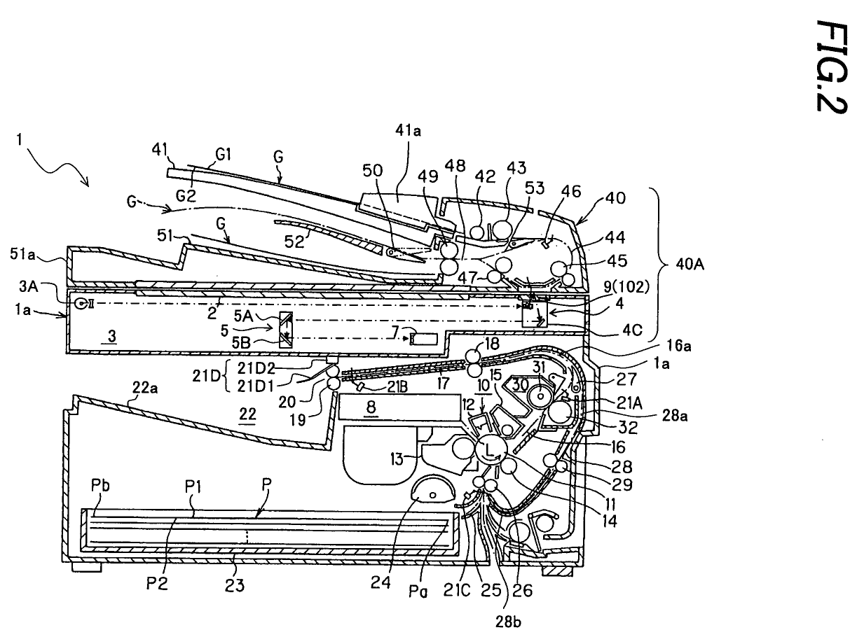

FIGS. 1 and 2 show one example of the embodiment of the present invention. FIG. 1 is a perspective view showing the overall configuration of an image forming apparatus according to one embodiment in which an image reading apparatus according to the present invention is adopted, and FIG. 2 is a sectional side view showing the internal configuration of the image forming apparatus.

To begin with, the overall configuration of an image forming apparatus 1 according to the present embodiment will be described.

Image forming apparatus 1 according to the present embodiment includes an image reader 40A (FIG. 2) for reading image information from an original G, and outputs the image information of original G, captured by the image reader 40A, by electrophotographically forming a monochrome image on recording paper of a predetermined sheet-like material (to be referred to hereinbelow as the paper) as a recording medium.

As shown in FIGS. 1 and 2, image forming apparatus 1 is provided with an original placement table (e.g., platen glass) 2 of transparent glass on which original G is placed, on the top of an apparatus body 1a. There is an automatic document processor 40 on the top of this original placement table 2 while a scanner portion (image reading portion) 3 as an image reader for reading image information from original G is arranged under this original placement table 2.

The original placement table 2, scanner portion 3 and automatic document processor 40 and others constitute the image reader 40A.

Arranged under scanner portion 3 are an image forming portion 10, a fixing unit 30 and a paper discharge portion 22. Provided further below is a paper feed cassette 23 which stores recording paper as recording media.

Scanner portion 3 is essentially composed of first and second scanner units 4 and 5 which are arranged under original placement table 2 and move reciprocatively in parallel therewith, an original image reading unit including a CCD (photoelectric transducer) 7 and an exposure lamp (light source) 3A.

Exposure lamp 3A has a light source and an optical lens element, and is fixed on one end side inside the body of scanner portion 3, at a position opposing the side end of first scanner unit 4 with respect to the main scan direction and in an area where it will not interfere with the movement of first scanner unit 4 and second scanner unit 5, and illuminates first scanner unit 4 along the sub-scan direction of scanner portion 3.

In the drawing, the optical path of the emitted light from exposure lamp 3A is shown with a dashed line.

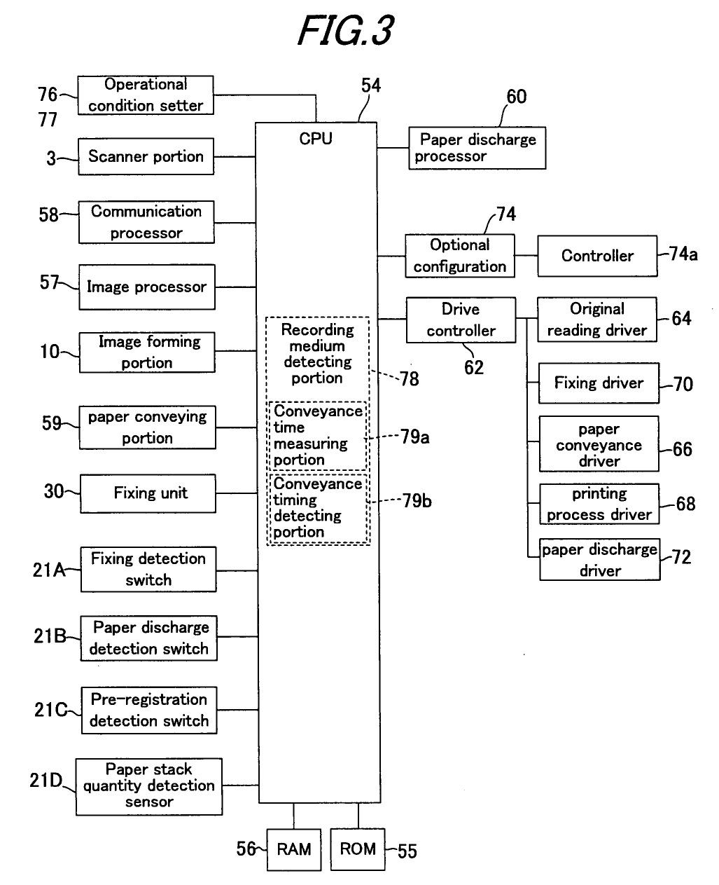

CCD (charge coupled device) 7 reads the light image of an original image and photoelectrically converts it into electric signals to thereby create original image information (original image data) and outputs the original image information to an aftermentioned image processor 57 (see FIG. 3).

Image processor 57 performs image processing on the original image information output from CCD 7 to produce printing image information (printing image data) with a resolution, density, etc. suited for printing. The printing image information obtained as a result of the image processing is transferred to an image data input portion of a laser scanning unit (LSU) 8.

Laser scanning unit 8 emits laser beams in accordance with the printing image information output from image processor 57 to illuminate the surface of a photoreceptor drum 11 as a constituent of image forming portion (image forming process) 10. Thereby, an electrostatic latent image of the printing image information is written on photoreceptor drum 11.

As shown in FIG. 2, image forming portion 10 is essentially comprised of photoreceptor drum 11 driven to rotate in the direction of the arrow, a main charger 12 for electrifying the photoreceptor drum 11 surface at a predetermined potential, laser scanning unit 8 for illuminating the photoreceptor drum 11 surface with laser beams for forming an electrostatic latent image, a developing unit 13 for developing the electrostatic latent image formed by irradiation of the laser beams from the laser scanning unit 8, with toner to form a visible image, a transfer roller 14 for transferring the toner image of the original image visualized by the developing unit 13 to the paper (corresponding to “recording medium”: also called “print paper”) P that is fed from an aftermentioned paper feed cassette 23 through a paper feed path 25, and a cleaning unit 15 for cleaning the leftover toner remaining on the photoreceptor drum 11 after transfer by the transfer roller 14, all these elements being arranged in the order mentioned along the photoreceptor drum 11 in its rotational direction.

Main charger 12 of image forming portion 10 also has the function of an unillustrated charge erasing device for erasing electricity on the photoreceptor drum 11 surface after cleaning by cleaning unit 15.

Fixing unit 30 has a heat roller 31 and a pressing roller 32 as shown in FIG. 2, and fuses the toner image transferred on paper P and fixes the toner image to paper P as the paper P is passed through and between heat roller 31 and pressing roller 32 by rotating heat roller 31 while the paper P being nipped between the heat roller 31 and pressing roller 32.

The paper P with a toner image transferred thereon as it being nipped between photoreceptor drum 11 and transfer roller 14 is separated from photoreceptor drum 11 and conveyed along a main conveying path 16 that joins the photoreceptor drum 11 and fixing unit 30 into and between heat roller 31 and pressing roller 32 of the fixing unit 30. Heat roller 31 and pressing roller 32 abut each other with a predetermined pressing force, forming a nip portion at that contact.

In fixing unit 30, the paper P held between heat roller 31 and pressing roller 32, i.e., at the nip portion, is heated by heat roller 31 and pressed by pressing roller 32, so that the unfixed toner image that has been transferred from the photoreceptor drum 11 is fixed to the paper P.

The paper P after the fixing by fixing unit 30 is conveyed to paper discharge path 17 and further conveyed by a paper discharge drive roller 18 toward a paper discharge roller 19 on the paper discharge port 20 side.

The passage status of paper P being conveyed into paper discharge path 17 is detected by a fixing detection switch 21A arranged downstream of fixing unit 30 when the paper P passes by the nip between heat roller 31 and pressing roller 32.

For a case of usual one-sided printing, the paper is directly conveyed by the rotational drives of paper discharge drive roller 18 and paper discharge roller 19 and discharged through paper discharge port 20 onto a paper output tray 22a which is formed in a space under scanner portion 3. The passage status of paper P through paper discharge roller 19 is adapted to be detected by a paper discharge detecting switch 21B arranged upstream of paper discharge roller 19.

Paper P is discharged to the side of the image forming portion 10 and the discharged paper P is output over cassette 23 and under scanner portion 3.

Arranged at the inner bottom of main apparatus body la is an exchangeable paper feed cassette 23, in which a stack of recording paper P of a predetermined paper size is accommodated. A crescent-shaped sheet pickup roller 24 is arranged over the paper delivering side of this paper feed cassette 23.

This paper pickup roller 24 picks up the paper, sheet by sheet, from the topmost of a stack of paper P in paper feed cassette 23 and conveys the paper downstream (for convenience, the delivery side of recording paper P (the cassette side) is referred to as upstream and the direction of conveyance is referred to as downstream) to a registration roller (also called “idle roller”) 26 in paper feed path 25.

A reference numeral Pa in the drawing designates the front end of paper P and Pb designates the rear end of paper P.

Arranged on the upstream side of registration roller 26 is a pre-registration detection switch 21C. This pre-registration detection switch 21C detects paper P that is fed and conveyed from paper feed cassette 23. This signal is used to adjust the paper feed timing of the paper to be fed to the aforementioned image forming portion 10.

In the case where duplex printing is performed, after printing by image forming portion 10 has been performed on one side of paper P, the paper P is sent into paper discharge path 17 after passage through fixing unit 30, then once conveyed to the paper discharge roller 19 side. In this condition, a paper path switching gate 27 that is disposed near fixing unit 30 is changed over, then paper discharge roller 19 is driven in reverse so that the paper P is switched back and guided into a sub conveyance path 28 for reversing the paper. Then, the thus guided paper P is rotationally driven by a sub-drive roller (inversion roller) 29 provided on this sub conveyance path 28 and conveyed to the upstream side of registration roller 26 once again, so that printing on the other side of paper P is performed.

On original placement table 2 of main apparatus body la an automatic document processor (document conveyor) 40 of a document feed type reversing automatic document reader (R-SPF) integrated with an original presser (original pressing cover) 51a is mounted in an openable manner, so that it constitutes image reader 40A in combination with scanner portion 3.

Image reader 40A is constructed so as to be able to perform an original reading operation for an individual document in the same control manner as in the conventional apparatus, and provision of automatic document processor (document conveyor) 40 makes it possible to perform double-sided reading of original G and also perform automatic sequential reading of a multiple number of originals G.

As shown in FIG. 2, automatic document processor 40 has a document tray 41 on which originals G are set. When a multiple number of originals G are continuously read, the originals G set on this document tray 41 are picked up, one by one, by a document pickup roller 42 so that original G is guided by a document drive roller 43 into a document feed path 44 and conveyed to the upstream side of a registration roller (PS roller) 45.

Provided on the upstream side of this PS roller 45 is a document input sensor 46 for enabling detection of the document size of original G. This document input sensor 46 detects the leading and trailing edges of original G, so that the original G can be controlled and conveyed to an original reading station 9 of a glass slit located adjacent to one side of original placement table 2, taking into account the timing of delivery based on the detected signals.

In this case, first scanner unit 4 of scanner portion 3 has been controlled and moved so that it is positioned for standby under document reading station 9.

As to the scan of original G that is conveyed over this document reading station 9, one side of the original, namely, the first image-scan side G1 is scanned at document reading station 9 by first scan unit 4 of scanner portion 3 while the original is being moved. Provided at this document reading station is a contact glass 102 which keeps the distance between the original and scanner portion 3 uniform.

Other operations such as image reading by CCD 7, image processing of image information, image forming including printing etc., are performed in the same manner as above.

The original G that has been scanned over contact glass 102 is then conveyed by a conveying roller 47 through a document discharge path 48 toward the document discharge roller 49 side.

When document reading is performed for one side only, the original is discharged onto a document output tray 51 by the switching control of a document switching gate 50.

When document reading is performed for both sides, by the switching control of document switching gate 50 original G is once discharged onto a middle tray 52 disposed between document tray 41 and document output tray 51, then is switched back into a document reversing path 53 by driving document discharge roller 49 in reverse. Then the original G is once again fed into document feed path 44 so that the original image on the underside of original G, namely the side G2 facing the image reader is scanned while the original image on the underside of original G is printed out on the first printing side P1 of paper P in the same manner as in the above-described one-side printing operation.

When this printing operation for the first printing side P1 of paper P has been finished, paper P is reversed by the above-described sheet reversing device, then fed again into image forming portion 10 so that the original image on the front side of original G that has been previously stored in the memory is printed on the second printing side P2.

As shown in FIG. 1, control switches 76 for allowing the user to set up the image forming conditions such as the sheet type of paper P (sheet thickness etc., in addition to sheet size), print number, magnification, density etc., are arranged on the front portion on the upper side of main apparatus body 1a of image forming apparatus 1.

Paper discharge portion 22 is mainly comprised of paper discharge path 17, paper discharge drive roller 18, paper discharge roller 19, paper discharge port 20 and paper output tray 22a.

Arranged on the outer side of paper discharge port 20 (on the paper output tray 22a side) is a paper stack quantity detecting sensor 21D, also called a full stack detecting sensor.

Paper stack quantity detecting sensor 21D is mainly composed of a detecting piece 21D1 which operates when the paper discharged and stacked abuts the detecting piece, and a sensor body 21D2 which outputs a signal in accordance with the operation of detecting piece 21D1.

Detecting piece 21D1 has a rod-shaped configuration with its one end engaged with the sensor body 21D2 side so that the other end side can pivot on the first end, and the piece is arranged obliquely downward and outward from the apparatus side (paper discharge port 20 side).

With this structure, paper stack quantity detecting sensor 21D is adapted to output a detection signal from sensor body 21D2 as the second end of detecting piece 21D1 is pushed upward when the discharged amount of stacked paper has reached a predetermined amount (height).

Next, a specific paper conveyance path configuration for the image forming apparatus of the present embodiment will be described.

As shown in FIG. 2, the paper conveyance path in image forming apparatus 1 is mainly comprised of paper feed path 25 for feeding the paper upwards from paper feed cassette 23 arranged at the bottom of the machine to image forming portion 10, main conveyance path 16 for conveying the paper from image forming portion 10 to paper discharge drive roller 18 by way of fixing unit 30; paper discharge path 17 for conveying the paper from paper discharge drive roller 18 to paper discharge roller 19; and sub conveyance path 28 for inverting paper P by driving paper discharge roller 19 in reverse to switch back the paper using inversion roller 29.

Paper feed path 25 is extended approximately linearly but gently curved, from an unillustrated separation roller which separates the paper, sheet by sheet if double or multiple sheets of paper are fed and is located on the downstream side of paper pickup roller 24 with respect to the paper's direction of conveyance, to registration roller 26 arranged in the vicinity of the lower side (the upstream side with respect to the paper's direction of conveyance) of photoreceptor drum 11 of image forming portion 10.

Main conveyance path 16 is formed approximately linearly from the downstream side of registration roller 26 to fixing unit 30 by way of image forming portion 10, and is followed by a curved part 16a that bends smoothly extending approximately upward from the exit side (the downstream side with respect to the paper's direction of conveyance) of fixing unit 30 toward paper discharge drive roller 18 (to the left in the drawing).

Paper discharge path 17 is extended approximately linearly between paper discharge drive roller 18 and paper discharge roller 19. Here it should be noted that the configuration of paper discharge drive roller 18 is not limited to the above.

In order to invert and convey paper P by driving paper discharge roller 19 in reverse, sub conveyance path 28 is joined to curved part 16a of main conveyance path 16 is configured so as to guide the paper that is switched back, by switching paper path switching gate 27 and convey the paper downwards by means of inversion roller 29 toward registration roller 26, once again.

Specifically, sub conveyance path 28 includes a first curved part 28a for deflecting the direction of movement of paper P that is conveyed in reverse from paper discharge path 17 towards the bottom of the machine and a second curved part 28b for deflecting the direction of movement of paper P that is conveyed around the bottom of the machine towards the registration roller 26.

Next, the control system of image forming apparatus 1 according to the embodiment will be described in detail with reference to the drawings.

FIG. 3 is a block diagram showing an electric controller configuration of the image forming apparatus according to the present embodiment.

As shown in FIG. 3, image forming apparatus 1 according to the embodiment performs processes such as image reading, image processing, image forming and conveyance of paper P, etc., by a central processing unit (CPU) 54 which performs control in accordance with the program stored beforehand in ROM (read only memory) 55, using temporal storage such as RAM (random access memory) 56 etc. It is also possible to use other storages such as a HDD (hard disk drive) etc., instead of ROM 55 and RAM 56.

In image forming apparatus 1, the image information of an original (original image data) captured by scanner portion (original reading portion) 3, or original image information transmitted from other terminal devices connected via an unillustrated communication network, is adapted to be input to image processing portion 57 by way of a communication processor 58.

Image processor 57 shapes the original image information stored in the storage such as RAM 56 or the like into a printing image that is suitable for printing (image forming onto paper), in accordance with the aforementioned program.

The printing image information is input to image forming portion 10.

Image forming portion 10, paper conveying portion (performing various detections and controls of paper P in paper feed path 25, main conveyance path 16 and sub conveyance path 28 (these are also called paper guides)) 59, fixing unit 30 and paper discharge processor (performing various detections and controls of paper P in paper discharge path 17) 60 are linked with respective drive controllers 62.

Paper conveying portion 59 conveys paper P through the printing stage (image information is printed in image forming portion 10) and the fixing stage where the paper P having been printed is fixed (in fixing unit 30) and then discharges the sheet to paper discharge portion (paper output tray 22a).

Here, paper conveying portion 59 receives detection signals from fixing detection switch 21A, paper discharge detecting switch 21B, pre-registration detection switch 21C etc.

Image forming apparatus 1 has an operational condition setter 77. This operational condition setter 77 sets up operational conditions for image forming and conditions of conveyance etc., in image forming apparatus 1, in accordance with the image forming request and the image forming conditions such as the type of recording media etc., designated by the user through control switches 76.

Further, in image forming apparatus 1, based on the set operating conditions, drive controller 62 is adapted to control drive actuators for the aforementioned scanner portion 3, paper conveying portion 59, image forming portion 10, fixing unit 30, paper discharge processor 60 etc., namely, an original reading driver 64, a paper conveyance driver 66, a printing process driver 68, a fixing driver 70 and a paper discharge driver 72 so that they can operate in synchronization with instructions from CPU 54 in accordance with the program stored in ROM 55.

Paper discharge processor 60 makes control of a paper discharge process of discharging the printed paper to the paper output tray and performs the paper discharge process based on the signal output from paper stack quantity detecting sensor 21D.

Original reading driver 64 includes a drive actuator for the first scan unit 4 and the second scan unit 5 of scanner portion 3.

Paper conveyance driver 66 means paper conveying portion 59, specifically, drive motors for paper pickup roller 24 and registration roller 26 along the aforementioned paper feed path 25.

Printing process driver 68 is a drive motor for photoreceptor drum 11.

Fixing driver 70 includes drive motors for heat roller 31 and pressing roller 32 in fixing unit 30.

Paper discharge driver 72 includes drive motors for paper discharge drive roller 18, paper discharge roller 19 etc. All these drive motors of the drivers may be configured of common or different motors or drive sources with appropriate power transmission mechanisms.

Further, image forming apparatus 1 may be used with automatic document processor (document conveyor) 40 as an optional configuration 74. Each optional configuration 74 incorporates an individual controller 74a separately from the controller of the image forming apparatus 1 so as to operate in synchronization with the main apparatus by performing timing adjustment via the aforementioned communication processor 58.

A recording medium detecting portion 78 detects arrival of the leading end of the recording medium at fixing unit 30 or the discharge portion. Recording medium detecting portion 78 is adapted to detect the timings at which the paper P arrives at (enters) fixing unit 30 and paper discharge drive roller 18, based on the conveyance timing of the recording medium detected by an aftermentioned conveyance timing detecting portion 79b.

Specifically, recording medium detecting portion 78 includes: a conveyance time measuring portion 79a for measuring the time of conveyance of paper P from when the paper P is delivered from registration roller 26 at the entrance of paper feed path 25 where the paper P is introduced; and a conveyance timing detecting portion 79b for detecting the timings at which paper P is conveyed in main conveying path 16 and in paper discharge path 17, based on the distances from registration roller 26 to fixing unit 30 and paper discharge drive roller 18 to be controlled and the paper P's speed of conveyance.

Next, image reader 40 which characterizes the present embodiment will be described in detail with reference to the drawings.

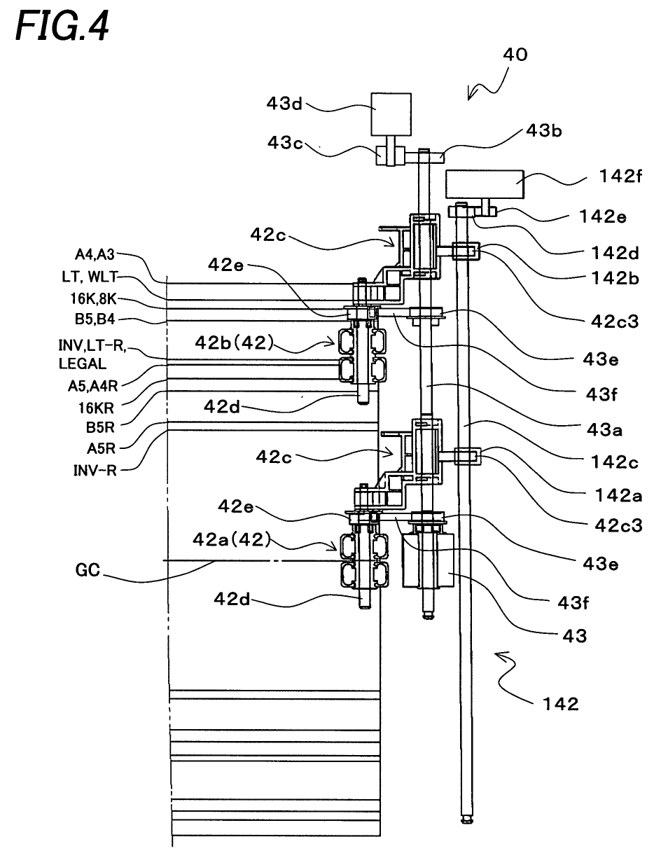

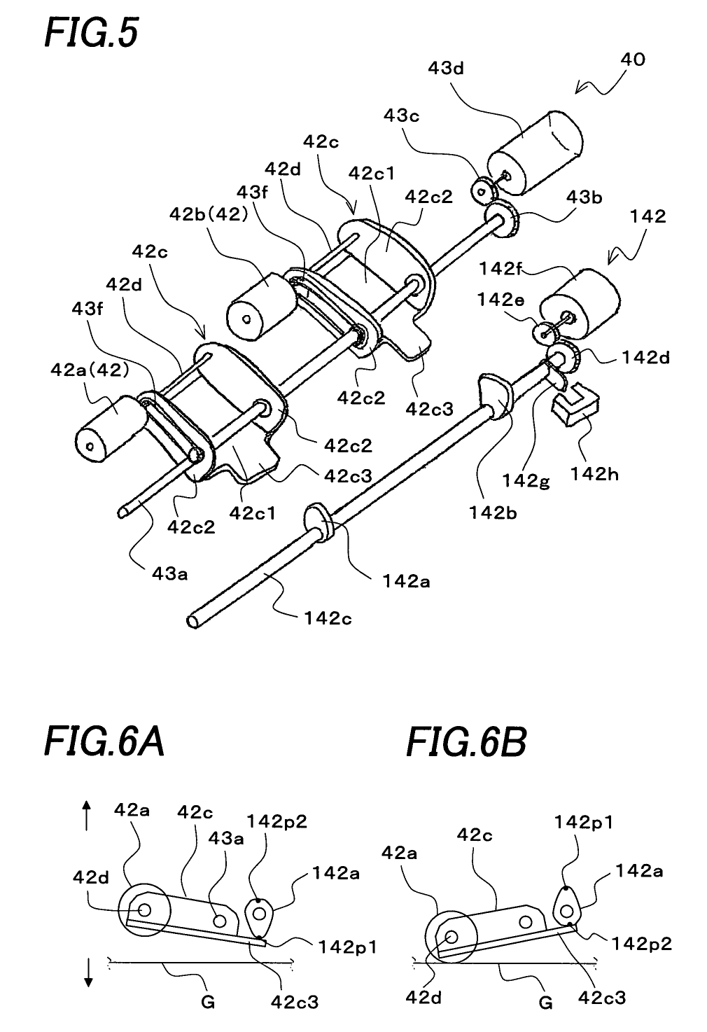

FIG. 4 is an illustrative view showing a schematic configuration of an automatic document processor that constitutes an image reading apparatus according to the present embodiment; FIG. 5 is an illustrative view showing a pickup roller configuration as a component of the automatic document processor; FIG. 6A is an illustrative view showing the pickup roller being retracted; and FIG. 6B is an illustrative view showing the pickup roller being active.

In automatic document processor 40 according to the present embodiment, as shown in FIG. 2, document tray 41 on which originals G are loaded has document positioning plates 41a (FIGS. 1 and 2) that regulate the loaded position of originals G stacked on the tray.

These document positioning plates 41a are arranged so as to hold originals G sideways therebetween and adapted so that the width or distance between document positioning plates 41a and 41a can be adjusted in accordance with the width size of originals G. Also, an unillustrated document size sensor is provided so as to detect the size of originals G based on the set position of document positioning plates 41a, and its detected result is supplied to an unillustrated controller.

Document pickup roller 42 is composed of two units (42a and 42b) arranged, side by side, along the direction (document width direction) approximately perpendicular to the direction of conveyance of loaded originals G, as shown in FIGS. 4 and 5. Each document pickup roller 42a, 42b is axially rotatably supported on a pickup roller holding axis 42d and held by a pickup roller holder (roller holding member) 42c.

In FIG. 4, the dashed line designated at GC represents the center of original G in the width direction. Also in FIG. 4, reference symbols and numerals A4, A3, LT, WLT, 16K, 8K, B5, B4, INV, LT-R, LEGAL, A5, A4R, 16KR, B5R, A5R and INV-R show the positions of the edges on one side of respective originals G when each original G is set with its center adjusted to the central position GC.

Pickup roller holder 42c is constructed as shown in FIG. 5 such that a pair of supports 42c2 and 42c2 are arranged opposing each other and upright from both edges of a bottom surface 42c1, forming a U-shaped section and that a pickup roller holding axis 42d is penetrated through the supports 42c2 and supported thereby while the pickup roller holder itself is pivotally supported on a drive shaft 43a which drives document drive roller (document conveyor) 43.

In the bottom surface 42c1 of pickup roller holder 42c, a cam-actuated part 42c3 that abuts an aftermentioned cam element 142a or 142b is projectively formed on the opposite side across drive shaft 43a from the document pickup roller 42 side.

Arranged at one end of drive shaft 43a is a driven gear 43b as shown in FIG. 4 so that rotational force from a drive motor (drive source for document feed) 43d is transmitted through a drive gear 43c.

A driven pulley 42e (FIG. 4) is provided on pickup roller holding axis 42d while a drive pulley 43e is arranged on drive shaft 43a so as to oppose the aforementioned driven pulley 42e, so that rotational force from the drive pulley can be transmitted to the driven pulley through a drive transmission belt 43f.

Arranged on the opposite side across document drive roller 43 from the side of document pickup rollers 42a and 42b is a pickup roller selecting mechanism (pickup roller selector) 142.

This pickup roller selecting mechanism 142 has a camshaft 142c on which cam elements (pickup roller shifters) 142a and 142b which respectively correspond to two units of document pickup rollers 42a and 42b are integrally provided.

As shown in FIG. 5, a driven gear 142d is arranged at one end of camshaft 142c so that rotational force from a drive motor (drive source for document feed) 142f is transmitted through drive gear 142e. The camshaft 142c is provided with a camshaft rotational position detector piece 142g for detecting the rotational state of camshaft 142c while a photo interrupter 142h for detecting this camshaft rotational position detector piece 142g is arranged adjacent to the detector piece.

The camshaft rotational position detector piece 142g in combination with photo interrupter 142h detects the rotational position of camshaft 142c so as to detect the initial position of operation (reference position).

Cam element 142a and 142b are arranged as shown in FIGS. 4 and 5 so that their outer peripheries respectively abut cam-actuated parts 42c3 of pickup roller holders 42c for holding document pickup rollers 42a and 42b.

With regard to the outer peripheral shapes of cam elements 142a and 142b, each element has a top dead center 142p1 and bottom dead center 142p2 formed at predetermined rotational angles.

For example, as describing the action of cam element 142a, when top dead center 142p1 of cam element 142a reaches the cam actuated part 42c3, cam actuated part 42c3 is pushed down, pivoting on drive shaft 43a. With this movement document pickup roller 42a is moved upwards in the drawing, separating from original G, as shown in FIG. 6A.

On the other hand, when bottom dead center 142p2 of cam element 142a reaches the cam actuated part 42c3, cam actuated part 42c3 returns to the original position. With this movement document pickup roller 42a moves downwards in the drawing, abutting original G, as shown in FIG. 6B.

Next, the operation of document pickup rollers 42 caused by pickup roller selecting mechanism 142 according to the present embodiment will be described in detail with reference to the drawings.

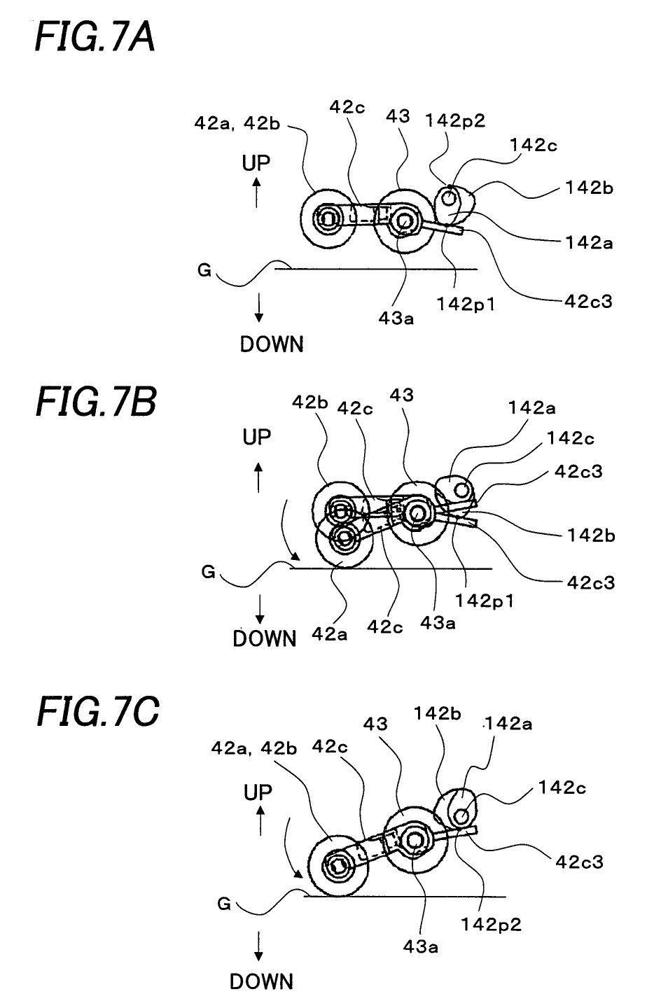

FIG. 7A is an illustrative view showing a state in which the document pickup rollers are kept away from the original by the function of the pickup roller selecting mechanism according to the present embodiment; FIG. 7B is an illustrative view showing a state in which one of the document pickup rollers is selectively made to abut the original by the pickup roller selecting mechanism; and FIG. 7C is an illustrative view showing a state in which all the document pickup rollers are made to abut the original by the pickup roller selecting mechanism.

Document pickup rollers 42a and 42b are adapted to pivot (shift) in accordance with the rotational angles of cam elements 142a and 142b of pickup roller selecting mechanism 142 as the cam elements rotate.

To begin with, in the initial state of document pickup rollers 42a and 42b, the top dead centers of cam elements 142a and 142b are set to abut and press down cam actuated parts 42c3 of pickup roller holders 42c, so that document pickup rollers 42a and 42b are kept away from original G, as shown in FIG. 7A. In this condition, for example, camshaft rotational position detector piece 142g may be set so as to be detected by photo interrupter 142h, to thereby establish the operation initial position (reference position).

When the set position of document positioning plates 41a (FIGS. 1 and 2) is determined depending on the size of originals G as shown in FIG. 4, an output signal corresponding to the original size is output. Drive motor 142f is rotated by a predetermined angle based on the output signal so as to rotate camshaft 142c by a predetermined amount.

As camshaft 142c rotates by a predetermined amount, the bottom dead center 142p2 of cam element 142a reaches cam actuated part 42c3 so that cam element 142a moves pickup roller holder 42c of document pickup roller 42a upwards while document pickup roller 42a located at the center, which defines the reference of document feed, moves down in the drawing and takes the position of abutment against the original G, as shown in FIG. 7B.

In this situation, cam element 142b rotates keeping the position of its top dead center so as to keep document pickup roller 42b away from original G.

That is, in this case, document pickup roller 42a abuts original G while document pickup roller 42b is separated from original G.

In a case where a document of a different size is detected or where a different document set condition is detected, camshaft 142c is further rotated by a predetermined amount, and the bottom dead center 142p2 of cam element 142b reaches cam actuated part 42c3 so that cam element 142b moves pickup roller holder 42c of document pickup roller 42b upwards while document pickup roller 42b located at one side in the document width moves down in the drawing and takes the position of abutment against the original G, as shown in FIG. 7C.

In this situation, cam element 142a rotates keeping the position of its bottom dead center so as to keep document pickup roller 42a in abutment with original G.

That is, in this case, both document pickup rollers 42a and 42b take the positions of abutment against original G.

In the above way, it is possible to select the conditions of abutment of document pickup rollers 42a and 42b against original G, by turning camshaft 142c in accordance with the document size and the document set state so as to change the timings of abutment of cam elements 142a and 142b that abut respective pickup roller holders 42c in accordance with the amount of rotation of camshaft 142c.

Here, though in the present embodiment, the gravity acting on document pickup rollers 42a and 42b is used to apply the predetermined contact pressure against original G, it is also possible to control the contact pressure of document pickup rollers 42a and 42b against original G by arranging elastic elements such as coil springs, leaf springs, rubber material, etc. to respective pickup roller holders 42c, so as to urge document pickup rollers 42a and 42b against original G.

Further, though in the present embodiment, the document pickup rollers 42 to be operated are selected in accordance with the output signal that is output corresponding to the document size when document positioning plates 41a are set in accordance with the document size, it is also possible to previously set up an output signal depending on the document weighting and select the document pickup rollers 42 to be operated in accordance with this output signal.

It is also possible to provide a configuration in which the size of an original to be read is designated through a control panel so that the document pickup rollers 42 to be operated are selected in accordance with the designated document size when an output request is made.

Next, automatic feed of originals G by automatic document processor 40 according to the present embodiment will be described in detail with reference to the drawings.

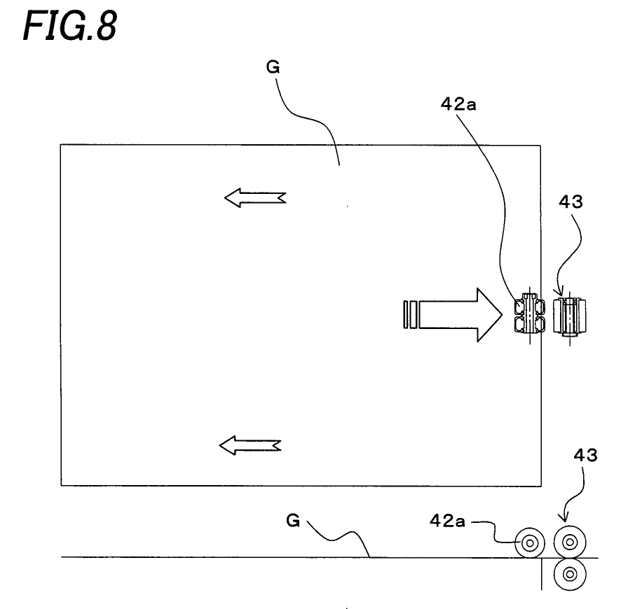

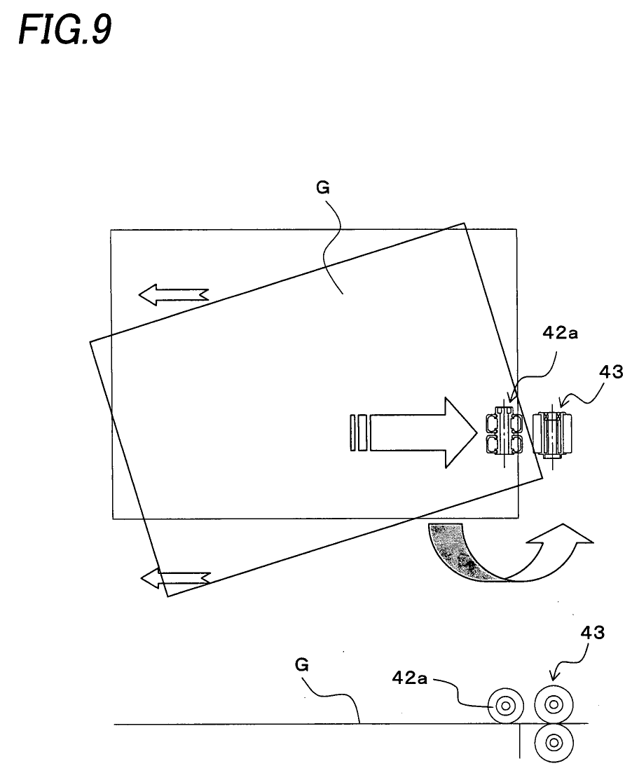

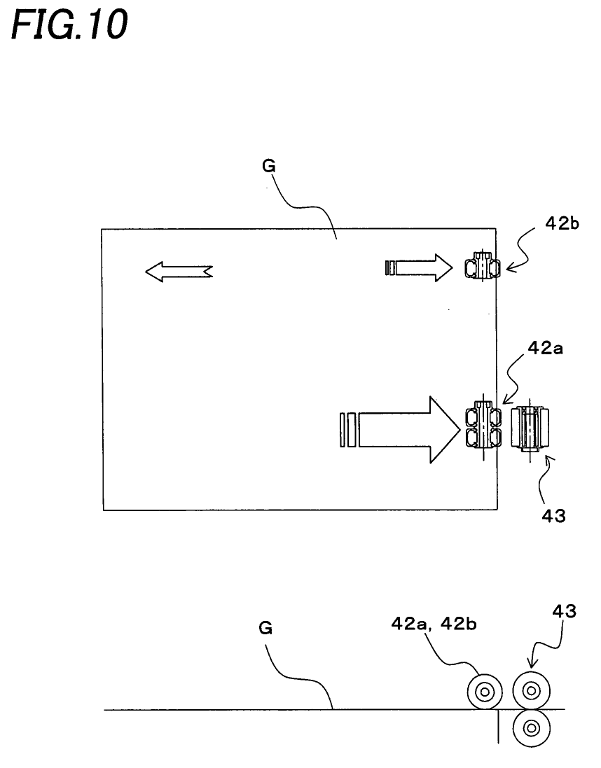

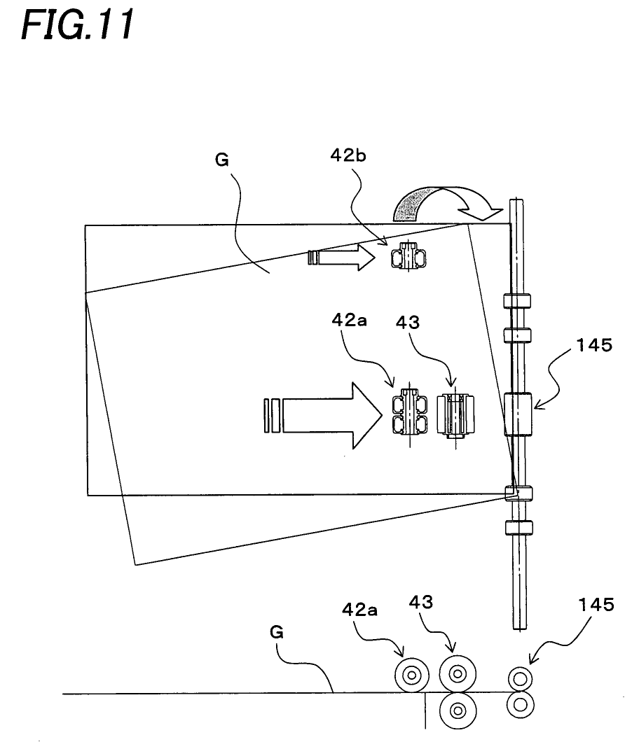

FIG. 8 is an illustrative view showing a document feed state in which an original is fed by the automatic document processor according to the present embodiment with its center adjusted to the center reference; FIG. 9 is an illustrative view showing a document feed state in which an original is fed by the same automatic document processor with its center not adjusted to the center reference; and FIG. 10 is an illustrative view showing a document feed state in which document pickup rollers are selectively operated in accordance with a case where an original is fed by the same automatic document processor with its center not adjusted to the center reference.

When, for example, original G is set with its center adjusted to the center reference in accordance with the size of the original G, the document pickup roller 42a that is located at the approximate center in the document width is selected to operate by pickup roller selecting mechanism 142 (FIG. 5), so that the original G can be conveyed by bringing document pickup roller 42a into contact with the approximate center of the original G. Accordingly, it is possible to convey the document substantially parallel in the document's direction of conveyance.

On the other hand, when original G is set with its center not adjusted to the center reference, an example where an original G having a different size is mixed in a stack of loaded documents is the case. In this case, if the original G is conveyed by document pickup roller 42a, document pickup roller 42a comes into contact with this original G at a point displaced from its center. As a result, the original G is pulled with its side closer to the document pickup roller first, so that the original G is conveyed on a skew, as shown in FIG. 9.

To avoid this, when original G is set with its center not adjusted to the center reference, the document pickup roller 42b that is located away from document pickup roller 42a is also selected to operate in combination with document pickup roller 42a as shown in FIG. 10, so that it is possible to make up for the document conveyance delay by document pickup roller 42b, hence it is possible to feed the original G correctly in the document's direction of conveyance.

Here, the state in which original G is set with its center not adjusted to the center reference also includes the case where an original G is set with its side edge adjusted as a reference, the case where an original G is incorrectly stacked, the case where an original G is set with its lateral direction vertical or vice versa, and other cases, in addition to the aforementioned case where an original G having a different size is mixed in a stack of loaded documents.

According to the present embodiment thus constructed as described heretofore, since two units of document pickup rollers 42a and 42b which are located so as to abut original G at different positions are provided, and these document pickup rollers 42a and 42b are selected to operate by pickup roller selecting mechanism 142 in accordance with the set state of original G, it is possible to constantly feed and convey originals G correctly without causing any mis-feed, multiple page feeding and skewing pages.

As a variational example of the present embodiment, a registration roller 145 may be arranged adjacent to document drive roller 43 on its downstream side with respect to the document's direction of conveyance, as shown in FIG. 11. In this configuration, if page skewing occurs during conveyance of a document and the skewing page needs to be corrected by registration roller 145, it is possible to easily correct the position of original G because document pickup roller 42b, which is disposed at a position distant from a fulcrum 145a to be the reference for positioning, is able to apply a great rotational moment to the document.

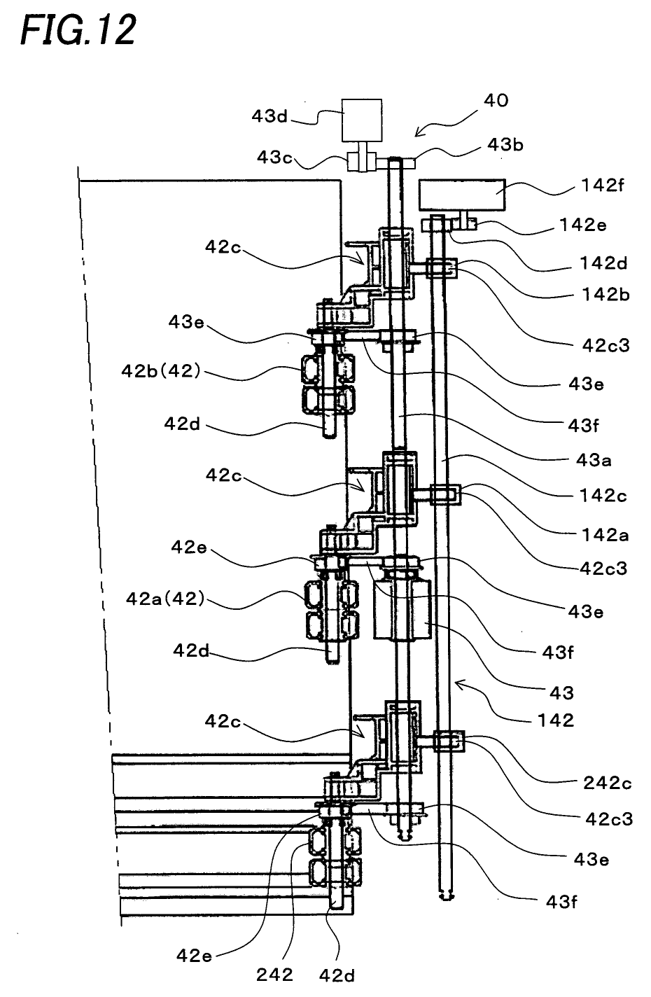

Further, though in the present embodiment, two document pickup rollers 42a and 42b are laid out at the center of original G and at a position near one side edge, the present invention should not be limited to the number and layout of pickup rollers. For example, a document pickup roller 242 having the same configuration as document pickup roller 42b and a cam element 242c corresponding to this document pickup roller 242 may be arranged on the opposite side with respect to the document width direction, as shown in FIG. 12.

Also, the present invention should not be limited to the material of document pickup rollers 42. For example, it possible to develop the arrangement of the present invention into a configuration in which multiple units of document pickup rollers which are constituted of optimal materials supporting for different materials of documents may be provided so that these document pickup rollers are selectively operated in accordance with the material of the document to be handled.

What is claimed is:

1. A document feeding device for automatically feeding documents, comprising:
a document tray capable of accommodating multiple pages of originals;
a document feed path for introducing and feeding originals from the document tray into the interior of a machine;
a pickup roller assembly for picking up and delivering originals, page by page, from the document tray to the document feed path; and
a document conveyor for conveying the original fed into the document feed path,
characterized in that the pickup roller assembly includes a plurality of pickup rollers and a pickup roller selector for selecting the pickup rollers to be operated, from the multiple pickup rollers, at least in accordance with the document size or the weighting of the document.

2. The document feeding device according to claim 1, wherein the pickup roller selector selects pickup rollers to be operated in accordance with a request for document reading, input to the document feeding device.

3. The document feeding device according to claim 1, wherein the pickup roller selector selects pickup rollers to be operated in accordance with the set position of document positioning plates for regulating the loaded position of documents in conformity with the size of the documents staked on the document tray.

4. The document feeding device according to claim 1, wherein the pickup roller is comprised of a roller holding member that is supported by a drive shaft coupled to a drive source for document feed for driving the document conveyor and a drive transmitter for transmitting the drive from the drive shaft, and a pickup roller shifter which pivots the pickup roller on the coaxial axis with the drive shaft to bring the pickup roller into, and out of, contact with the original is provided.

5. The document feeding device according to claim 4, wherein the pickup roller shifter has a cam element and shifts the position of the pickup roller by rotating the cam element.

6. The document feeding device according to claim 5, wherein the pickup roller shifter varies the contact pressure between the pickup roller and the original depending on the shape of the cam element.

7. The document feeding device according to claim 1, wherein the contact pressure between the pickup roller and the document is set to be maximized for the pickup roller arranged close to the document placement reference position and become smaller for one that is located more distant from the reference position.

8. The document feeding device according to claim 1, wherein the contact pressure between the pickup roller and the document is set to become smaller as the size of the original is smaller and as the weighting of the original is smaller.

9. The document feeding device according to claim 1, wherein a registration roller for controlling document feed is arranged downstream of the pickup roller assembly with respect to the document's direction of conveyance.

10. An image reading apparatus for reading originals automatically, comprising:
an image reading portion for scanning an original image line-wise to convert the image into electric signals by a photoelectric transducer and output the signals; and
a document feeding device for automatically feeding originals,
characterized in that the document feeding device comprises a document feeding device defined in claim 1.

11. The document feeding device according to claim 1, wherein the pickup roller is comprised of a roller holding member that is supported by a drive shaft coupled to a drive source for document feed for driving the document conveyor and a drive transmitter for transmitting the drive from the drive shaft, and a pickup roller shifter which pivots the pickup roller on the coaxial axis with the drive shaft to bring the pickup roller into, and out of, contact with the original is provided.

12. The document feeding device according to claim 1, wherein the pickup roller is comprised of a roller holding member that is supported by a drive shaft coupled to a drive source for document feed for driving the document conveyor and a drive transmitter for transmitting the drive from the drive shaft, and a pickup roller shifter which pivots the pickup roller on the coaxial axis with the drive shaft to bring the pickup roller into, and out of, contact with the original is provided.

13. The document feeding device according to claim 1, wherein the contact pressure between the pickup roller and the document is set to be maximized for the pickup roller arranged close to the document placement reference position and become smaller for one that is located more distant from the reference position.

14. The document feeding device according to claim 1, wherein the contact pressure between the pickup roller and the document is set to be maximized for the pickup roller arranged close to the document placement reference position and become smaller for one that is located more distant from the reference position.

15. The document feeding device according to claim 1, wherein the contact pressure between the pickup roller and the document is set to become smaller as the size of the original is smaller and as the weighting of the original is smaller.

16. The document feeding device according to claim 1, wherein the contact pressure between the pickup roller and the document is set to become smaller as the size of the original is smaller and as the weighting of the original is smaller.

17. The document feeding device according to claim 1, wherein a registration roller for controlling document feed is arranged downstream of the pickup roller assembly with respect to the document's direction of conveyance.

18. The document feeding device according to claim 1, wherein a registration roller for controlling document feed is arranged downstream of the pickup roller assembly with respect to the document's direction of conveyance.

19. An image reading apparatus for reading originals automatically, comprising:
an image reading portion for scanning an original image line-wise to convert the image into electric signals by a photoelectric transducer and output the signals; and
a document feeding device for automatically feeding originals,
characterized in that the document feeding device comprises a document feeding device defined in claim 1.

20. An image reading apparatus for reading originals automatically, comprising:
an image reading portion for scanning an original image line-wise to convert the image into electric signals by a photoelectric transducer and output the signals; and
a document feeding device for automatically feeding originals,
characterized in that the document feeding device comprises a document feeding device defined in claim 1.
